(19) United States
(12) Patent Application Publication
(10) Pub. No.: US 2003/0070063 A1
(43) Pub. Date: Apr. 10, 2003

(54) Configuration file caching

(75) Inventors: Craig Boyle, Auburn, MA (US); Ajit Nair, Framingham, MA (US); Donghai Ma, Acton, MA (US); Huimin Li, Milford, MA (US); Benoit Legault, North Attleboro, MA (US)

Correspondence Address: LEFFERT JAY & POLGLAZE, P.A., P.O. BOX 581009, MINNEAPOLIS, MN, 55458-1009, US

(73) Assignee: ADC Telecommunications, Inc.

(21) Appl. No.: 09/972,258

(22) Filed: Oct. 5, 2001

(51) Int. Cl. G06F 15/177

(52) U.S. Cl. 713/2

(57) ABSTRACT

A method and apparatus for providing access to configuration files even if a remote server containing configuration profile information is unavailable includes caching known configuration files locally, and using the known configuration files in the event of a remote server failure or overload.

The present invention relates generally to telecommunications, and more specifically to startup processes for telecommunications devices.

### BACKGROUND

Whenever an end user communications access device boots up, it must be configured. For communications devices attached to an internet, intranet, or other communications network, the boot process typically involves retrieving from a central server associated with an internet service provider or the like a series of configuration profiles containing profile and configuration information for such communications devices. The configuration profile is configured by a local server such as a dynamic host configuration protocol (DHCP) server into a configuration file. This configuration file provides the communication device with the initialization sequences that it needs to properly configure itself for communication with the network, and for proper operation. Configuration files are used for configuring such communications devices as cable modems, modems, and the like.

Centralized storage allows an internet service provider the opportunity to control access and to make configuration settings changes according to potentially dynamically changing situations. However, for the most part, the majority of a configuration file remains constant from one boot sequence to another. Further, minor changes in a configuration file do not necessarily render the configuration file invalid. An older configuration file may simply be not as up to date as a new configuration file, but will serve to allow the device to boot, and even to connect to the network or the like.

There are instances when a central server storing configuration profiles and configuration information is not available. Such times include, by way of example only and not by way of limitation, situations in which a power outage has occurred or a communication line has been cut. Following a power outage, a large number of devices may attempt to reconnect to the network at the same time. An overload of the resources of the central server can lead to server malfunctions, lockouts of some devices trying to access the configuration information, or very slow access times. In cases of power outages and other unanticipated interruptions of availability of the central server, configuration information is unlikely to have changed significantly, if at all.

In other instances, the central server may be unavailable due to system maintenance or problems at the internet service provider. This does not necessarily mean that the network itself is unavailable, but if an access device cannot get configuration information, it will not be able to boot properly.

Therefore, there is a need in the art for an improved method for booting access devices when a central server containing configuration profile information is not available.

### SUMMARY

In one embodiment, a method of booting a communications access device includes contacting a central server for a configuration profile for the access device, and retrieving a new configuration profile for the access device if the central server is available. If a new configuration profile is retrieved, a new configuration file is created from the retrieved profile, and a copy of the new configuration file is stored in a secondary location. If the central server is unavailable, a known configuration file is retrieved from a secondary location. The device is booted using the known configuration file if the central server is unavailable and the new configuration file if the central server is available.

In another embodiment, a method for providing boot access to a network includes storing a known configuration file for an access device locally, attempting to retrieve a new configuration profile from a remote server upon receiving a boot request at a local server, retrieving the new configuration profile and creating a new configuration file from the retrieved profile if the remote server is available, and retrieving the stored known configuration file if the remote server is not available.

In still another embodiment, a boot access configuration method includes retrieving a configuration profile from a central server, creating a new configuration file from the profile, and storing a copy of the configuration file on a local server. The new configuration file is provided to an access device if created, and a retrieved copy is provided to the access device if the central server is unavailable during a subsequent access.

In yet another embodiment, a method of re-registering a communications access device after a failure condition includes determining whether a predetermined failure condition of a central server connection has occurred, and retrieving a cached configuration file from a local storage device if the predetermined failure condition is met.

In another embodiment, a communications system includes a provisioning server connected to a central server, with the central server storing configuration settings for access devices connected to the provisioning server, a data structure on the provisioning server storing configuration files created from configuration settings for the access devices connected to the provisioning server, and a computer program executing a method. The method includes retrieving a new configuration profile from the central server for an access device requesting access, creating a new configuration file from the retrieved profile, caching the new configuration file to the data structure, and booting the device using the new configuration file if the central server is available. If the central server is unavailable, a known configuration file is retrieved from the provisioning server if the central server is unavailable, and the device is booted using the known configuration file.

Other embodiments are described and claimed.

### BRIEF DESCRIPTION OF THE DRAWINGS

FIG. 1 is a block diagram of a system according to one embodiment of the present invention;

FIG. 2 is a flow chart diagram of a method according to another embodiment of the present invention;

FIG. 3A is a block diagram of a system according to yet another embodiment of the present invention;

FIG. 3B is a message flow diagram according to another embodiment of the present invention;

FIG. 3C is a message flow diagram according to yet another embodiment of the present invention;

FIG. 4 is a flow chart diagram of a method according to still another embodiment of the present invention;

FIG. 5 is a block diagram of a communications system according to another embodiment of the present invention;

FIG. 6 is a flow chart diagram of a method according to another embodiment of the present invention; and

FIG. 7 is a block diagram of a system according to yet another embodiment of the present invention.

### DETAILED DESCRIPTION

In the following detailed description of the embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present invention, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

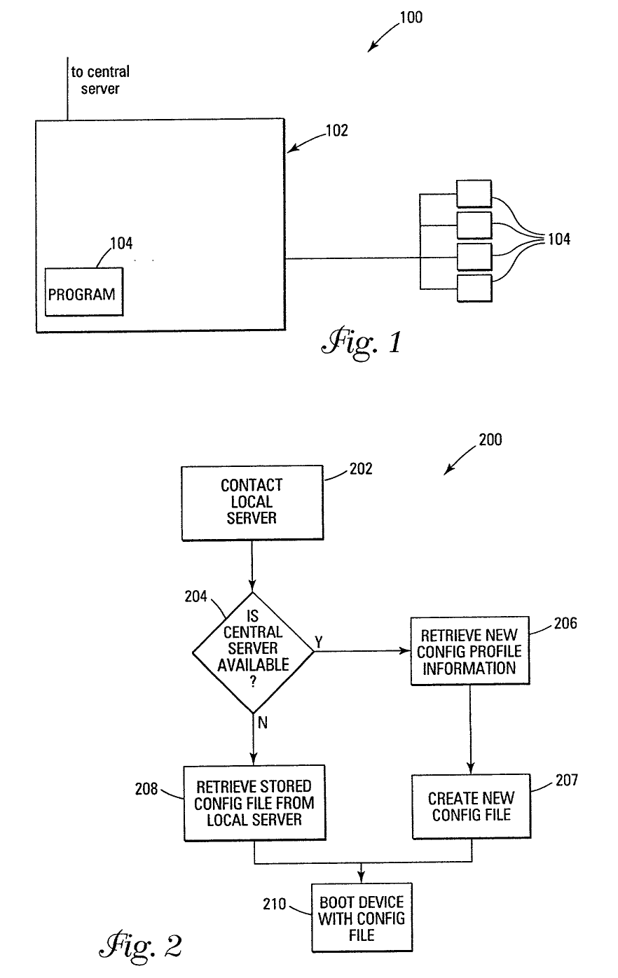

Referring to FIG. 1, a system 100 according to one embodiment of the present invention is shown. System 100 comprises a provisioning or secondary server 102. In one embodiment, the provisioning server is a distributed server connectable to multiple cable modems or other customer provided equipment (CPE). The provisioning server stores configuration files created from configuration profile information that is stored on a central server to which the provisioning server connects. A computer program resident on the provisioning server receives access requests from one or more of the access devices 104 connected to the provisioning server 102.

When a request is received to connect an access device that is being booted to the network, the computer program requests the configuration information for the particular access device from the central server. If the central server is operable, and the access device 104 is registered with the central server, the configuration information is returned from the central server to the provisioning server, a configuration file is created from the configuration information, and the configuration file is passed to the access device. If the central server is unavailable, the computer program consults a locally stored data file of known configuration files for the access devices, and retrieves a last known configuration file for the particular access device, based on unique information present on each access device.

The provisioning server 102 stores the known configuration files on a hard drive or other mass storage within the server 102 in one embodiment, and stores the known configuration files on an external, local mass storage device such as a hard disk or the like in another embodiment.

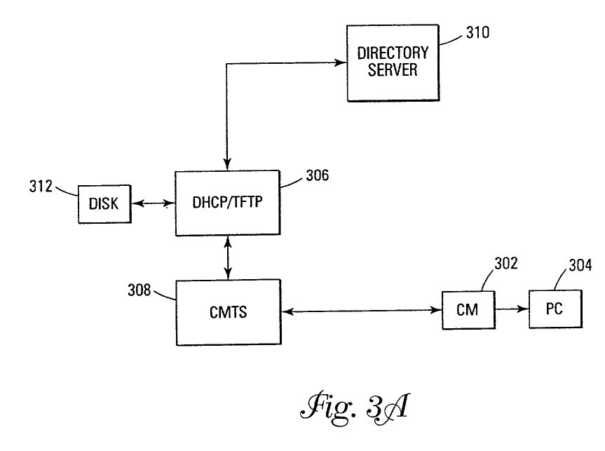

FIG. 2 is a flow chart diagram of a method 200 according to another embodiment of the present invention. Method 200 comprises an access device contacting a local server connected to a central server for a configuration file in block 202, and determining in block 204 whether the central server is available. If the central server is available, configuration profile information is retrieved from the central server in block 206, and a configuration file is created from the profile information in block 207. If the central server is not available, a known configuration file is retrieved from a secondary location in block 208. In block 210, the device is booted with either a new configuration file generated with configuration profile information from the central server if it is available, or with the known configuration file retrieved from the secondary location. The secondary location in one embodiment is a local provisioning server. The central server in one embodiment is a remote server.

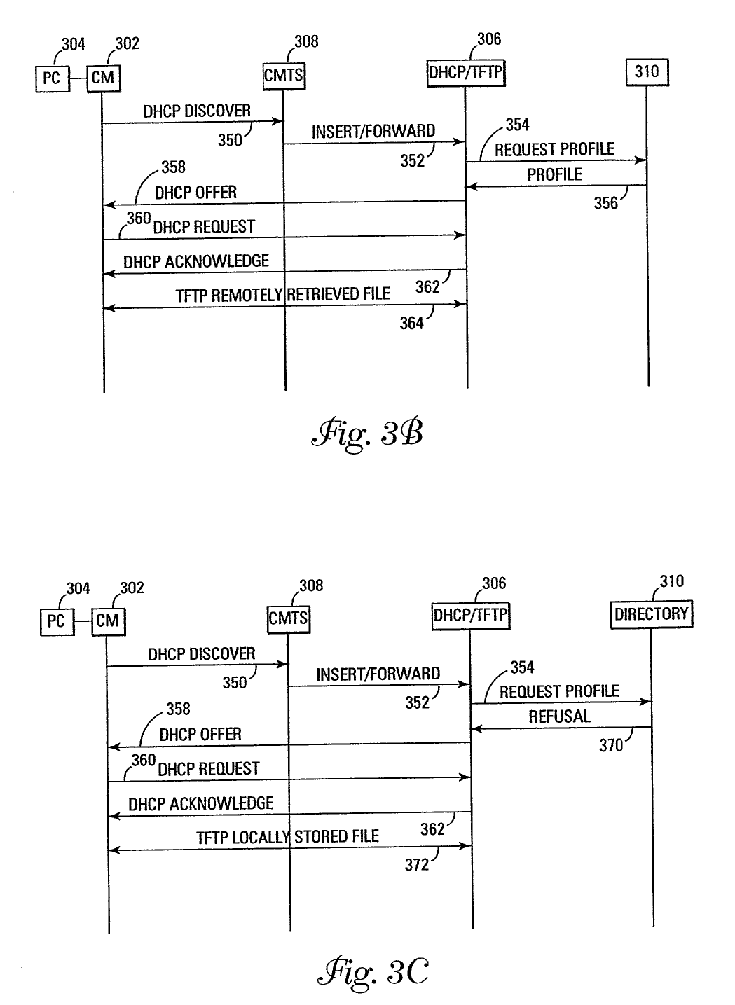

The various process blocks of method 200 are carried out for a cable modem in the following ways. Referring to FIG. 3A, a communications network is shown. The communications network comprises a cable modem 302 or other CPE connected to a personal computer (PC) 304. The cable modem 302 is connected to a cable modem termination system (CMTS) 308, which is in turn connected to communicate with a dynamic host configuration protocol (DHCP) server 306 with trivial file transfer protocol (TFTP) capability. The DHCP server 306 is connected to communicate with a directory server 310, and with a disk or other mass storage system 310. The directory server 310 is in one embodiment a remote server. In another embodiment, the directory server 310 is a locally maintained server separate from the DHCP server 306.

FIG. 3B is a message flow diagram for a process of creating a configuration file for an access device in which a central server is available. When a user wishes to access the communications network to which it is connected, it sends a request (350) to a dynamic host configuration protocol (DHCP) server 306 for configuration information. The request is received at a cable modem termination system (CMTS) 308. The CTMS inserts a gateway interface address and forwards the request 3(52) to the DHCP server 306. The DHCP receives the request, and attempts to retrieve a cable modem profile (354) for creating a configuration file from a directory server 310. If the directory server is available, a cable modem profile is retrieved (356) from the directory server 310, a new configuration file is created from the retrieved profile, and the configuration file is stored or cached locally on the DHCP server 306 or other locally available storage such as disk 312. Once the cable modem profile has been received and stored locally, the DHCP server 306 sends a DHCP offer (358) to the cable modem 302. The DHCP offer contains information regarding the internet protocol (IP) address, a subnet mask, the domain naming system (DNS), the gateway interface address, and a trivial file transfer protocol (TFTP) file name for the configuration file.

Once the DHCP offer has been received by the cable modem 302, the cable modem sends a DHCP request message (360) confirming receipt of the offer, requesting access given the IP address, subnet mask, DNS, and gateway interface address. If this message sent to the DHCP server 306 from the cable modem 302 contains the proper information, that is the information transmitted in the DHCP offer, the DHCP server 306 acknowledges the request (362). Once the request is made and acknowledged, the cable modem 302 obtains the new configuration file (364) having the transmitted configuration file name via TFTP.

FIG. 3C is a message flow diagram for a process of creating a configuration file for an access device in which a central server is not available. Messages 350, 352, and 354 are identical to those of FIG. 3B. If the central server is not available, a refusal (370) or no message at all is received from the central server. At this point, if a cable modem profile is not received from the directory server 310, then a locally cached copy of the last known configuration file created from a cable modem profile received from the directory server 310 is retrieved from local storage. As has been mentioned, such storage is on the DHCP server 306, disk 312, or the like. Once the last known configuration has been retrieved locally, the DHCP server 306 sends a DHCP offer (358) to the cable modem 302. The DHCP offer contains information regarding the internet protocol (IP) address, a subnet mask, the domain naming system (DNS), the gateway interface address, and a trivial file transfer protocol (TFTP) file name for the locally retrieved configuration file. Once the DHCP offer has been received by the cable modem 302, the cable modem sends a DHCP request message (360) confirming receipt of the offer, requesting access given the IP address, subnet mask, DNS, and gateway interface address. If this message sent to the DHCP server 306 from the cable modem 302 contains the proper information, that is the information transmitted in the DHCP offer, the DHCP server 306 acknowledges the request (362). Once the request is made and acknowledged, the cable modem 302 obtains the locally retrieved configuration file (372) 1having the transmitted locally retrieved configuration file name via TFTP.

In one embodiment, the directory server and the DHCP server are maintained at different locations and by different entities. The DHCP server relies on the directory server for configuration files, but stores known good files locally so that in the event of unavailability of the directory server, a request for configuration information from a cable modem or other CPE requiring configuration information is still granted.

In another embodiment, the directory server and the DHCP server are maintained at the same location. Storage of the cable modem profile is still at the directory server, but the directory server is maintained at the same location as the DHCP server. The main profile information is maintained on the directory server, and cached configuration files are stored on the DHCP server or other local disk storage and the like, as discussed above.

The storage of cached configuration files for cable modems or other CPEs connected to the local DHCP server allows for fast re-registration of devices after a mass interruption of service, such as occurs with a power outage, DHCP server failure, severed pipeline, or the like. Such a mass interruption of service is typically remedied all at once, and therefore a large number of CPEs or cable modems attempt to re-register with the DHCP server all at once. When such an event occurs, the DHCP server is often taxed beyond its capabilities, and it may fail, run very slowly, or the like. This results in an inability of users to reconnect to a network. In the case of business connections, such a network failure compounds with an inability to quickly reconnect after the failure is remedied, resulting in dissatisfied customers. Further, in some situations, a directory server may be overwhelmed with requests for configuration information, for example, early on a Monday morning when businesses typically open.

In another embodiment 400 shown in flow chart diagram in FIG. 4, a method for fast re-registration of cable modems and CPEs to a network is shown. This method 400 is used, for example, after power is restored or recovery from a failure occurs. In such circumstances, it is likely that a large number of CPEs and cable modems will be attempting to re-register with the network, and it is unlikely that many significant or major changes will have occurred with the configuration information normally obtained from a directory server. Therefore, the method 400 retrieves cached configuration file information without contacting the directory server.

Method 400 comprises determining whether a predetermined failure condition of a type not likely to have caused major configuration information changes has occurred and been remedied in block 402, and retrieving a cached configuration file from local storage if the predetermined failure condition has been met in block 404. Once the cached configuration file is retrieved in block 404, the configuration file is made available to the device requesting access in block 406. One process for making the file available is described above with respect to FIG. 3. Predetermined failure conditions for which fast re-registration methods are appropriate include, by way of example only and not by way of limitation, recovery from a central directory or DHCP server failure, restoration of power after an outage, restoration of line service after a failure, and the like. If a predetermined failure condition is not met, normal procedures for configuration file retrieval, such as those described above in methods 200 or 300, are initiated in block 403.

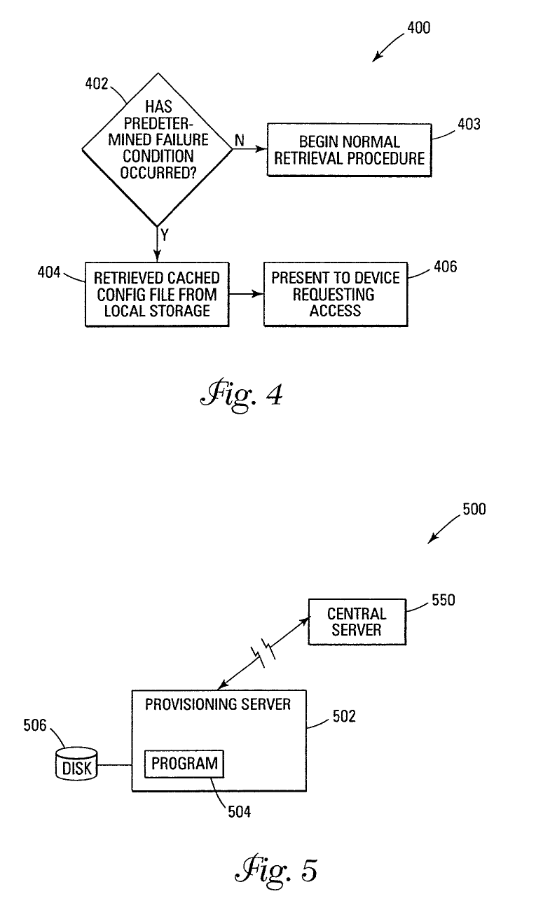

In another embodiment shown in FIG. 5, a communications system 500 comprises a provisioning server 502 which is connectable to a central server such as directory server 550. The central server 550 stores configuration settings and information for access devices such as cable modems and other CPEs which are connectable to a network via the provisioning server. A computer program 504 is stored on the provisioning server 502, and executes from main memory of the provisioning server 502. The computer program 504 accepts signals representative of a request from a cable modem or CPE, and sends a request to a directory server such as directory server 550 for a configuration profile for the specific cable modem or CPE which is requesting the information. The program monitors the response of the directory server. If the directory server is unavailable, no response is received, or information relating to the unavailability of the directory server is received. When no information or an unavailable signal is received from the directory server, the program retrieves a known good configuration file from local storage, either on a hard drive or other mass storage of the provisioning server, or on a separate local mass storage medium such as disk 506, and is conveyed to the cable modem or CPE. If the directory server is available, the configuration information is retrieved from the directory server, a new configuration file is created from the retrieved information, and the new configuration file is conveyed to the cable modem or CPE.

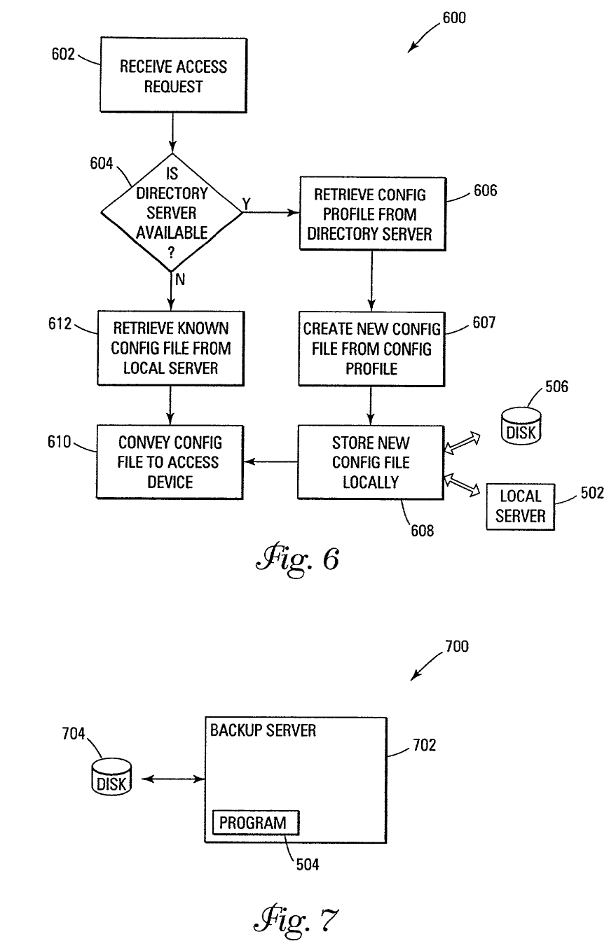

The program 504 in one embodiment executes a method 600 according to the flow chart diagram of FIG. 6. Method 600 comprises receiving a request for access to a network in block 602, and determining the availability of a directory server in decision block 604. If the directory server is available, process flow continues with retrieving configuration profile information from the directory server in block 606. Once the configuration profile is retrieved, the configuration file profile is used to dynamically generate a configuration file in block 607. The new configuration file is stored locally in block 608, such as in a local server such as server 502 or a local disk such as disk 506. A configuration file that has been cached or stored locally is retrieved in block 612 if the directory server is determined to be unavailable in block 604. The appropriate configuration file is conveyed to access device in block 610.

A backup communications access system 700 is shown in FIG. 7. Backup communications access system 700 comprises a server 702 storing cached known good configuration information files for cable modems or other CPEs for which the server 702 provides access. The known good configuration files are stored in one embodiment in a data file or lookup table for quick access by the server 702. In another embodiment, the configuration files are stored in a separate mass storage device such as disk 704. A computer program such as computer program 504 discussed above runs on the server in the manner described above.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method of booting a communications access device, comprising:
contacting a central server for a configuration profile for the communications access device;
retrieving a new configuration profile from the central server if the central server is available;
creating a new configuration file for the access device if a new configuration profile is retrieved;
retrieving a known configuration file from a secondary location if the central server is unavailable; and
booting the device using the new configuration file if the central server is available and using the known configuration file if the central server is not available.

2. The method of claim 1, wherein the secondary location mirrors the central server.

3. The method of claim 1, wherein the secondary location is a distributed server.

4. The method of claim 1, wherein retrieving a known configuration file comprises:
checking if the device is a registered device with the secondary location; and
retrieving a stored configuration file for the device.

5. The method of claim 4, wherein retrieving a stored configuration file comprises retrieving an older configuration file stored locally on a provisioning server.

6. The method of claim 4, wherein retrieving a stored configuration file comprises retrieving an older configuration file stored locally on an external mass storage device.

7. A method for providing boot access to a network, comprising:
storing a known configuration file for an access device locally;
attempting to retrieve a new configuration profile from a remote server upon receiving a boot request at a local server;
retrieving the new configuration profile if the remote server is available;
creating a new configuration file from the retrieved configuration profile if the remote server is available; and
retrieving the stored known configuration file if the remote server is not available.

8. The method of claim 7, wherein storing a known configuration file comprises storing on a local server.

9. The method of claim 7, wherein storing a known configuration file comprises storing on a local external disk.

10. The method of claim 7, wherein retrieving the stored known configuration file comprises:
accessing a storage file on the local server, the storage file containing a table of known configuration files for access devices.

11. The method of claim 7, and further comprising:
providing the new configuration file to the access device if the central server is available; and
providing the stored configuration file to the access device if the central server is unavailable.

12. A boot access configuration method, comprising:
retrieving a configuration profile from a central server;
creating a configuration file from the configuration profile;
storing a copy of the configuration file on a local server;
providing the configuration file to an access device; and
retrieving the copy if the central server is unavailable during a subsequent access.

13. The method of claim 12, wherein retrieving the copy comprises:
retrieving a known configuration file from the local server.

14. A method of re-registering a communications access device, comprising:
determining whether a predetermined failure condition of a central server connection has occurred; and
retrieving a cached configuration file from a local storage device if the predetermined failure condition is met.

15. The method of claim 14, wherein retrieving a cached configuration file comprises retrieving from a local provisioning server.

16. The method of claim 14, wherein retrieving a cached configuration comprises retrieving from a local external mass storage device.

17. The method of claim 14, and further comprising:
retrieving a configuration profile from the central server if the predetermined failure condition is not met; and
creating a new configuration file from the retrieved configuration profile.

18. A boot method for a communications device, comprising:
receiving a bootup request at a local server;
retrieving a new configuration profile for the access device from a remote server if the remote server is available;
creating a new configuration file from the retrieved configuration profile if the remote server is available; and
retrieving a copy of a known configuration file from the local server if the remote server is unavailable.

19. The boot method of claim 18, and further comprising:
providing the new configuration file to the communications device if the remote server is available; and
providing the known configuration file to the communications device if the remote server is unavailable.

20. The boot method of claim 18, wherein retrieving a copy comprises:
determining if the remote server is unavailable;
accessing a storage file containing known configuration files for communications devices; and
retrieving the known configuration file corresponding to the communications device requesting a configuration file.

21. A method of providing configuration files to an access device, comprising:
receiving a configuration file request from an access device at an access device termination system;
inserting a gateway interface address into the configuration file request at the access device termination system;
forwarding the configuration file request to a dynamic host configuration protocol (DHCP) server;
determining availability of a remote directory server;
retrieving an access device configuration profile from the directory server to the DHCP server if the directory server is available;
creating a new configuration file from the retrieved configuration profile if the directory server is available;
caching the new configuration file at the DHCP server;
retrieving an appropriate cached access device configuration file from the DHCP server if the directory server is unavailable;
making a DHCP offer containing configuration file name and retrieval information to the access device;
receiving a DHCP request containing the retrieval information from the access device;
acknowledging the DHCP request if the retrieval information is correct; and
transferring the configuration file to the access device.

22. The method of claim 21, wherein transferring is accomplished via trivial file transfer protocol.

23. The method of claim 21, wherein transferring the configuration file comprises:
transferring the new configuration file created from the new configuration profile if the directory server is available; and
transferring the cached access device configuration pro retrieved from the local server if the directory server is unavailable.

24. The method of claim 21, and further comprising:
determining whether a predetermined failure condition of the directory server connection has occurred; and
retrieving an appropriate cached access device configuration file from the DHCP server if the predetermined failure condition has occurred.

25. The method of claim 24, wherein the predetermined failure condition is selected from a group consisting of directory server power outage, DHCP server power outage, network power outage, access pipeline failure, and overtaxed directory server.

26. A computer readable medium for causing a computer to execute a method, the method comprising:
receiving a bootup request from an access device at the computer;
retrieving a new configuration profile for the access device from a remote server if the remote server is available;
creating a new configuration file from the retrieved configuration profile if the remote server is available; and
retrieving a copy of a known configuration file for the access device from the computer if the remote server is unavailable.

27. The computer readable medium of claim 26, wherein retrieving a copy comprises:
determining availability of the remote server;
accessing a storage table containing a plurality of cached known configuration files; and
retrieving a cached known configuration file corresponding to the access device.

28. The computer readable medium of claim 26, wherein the method further comprises:
caching a copy of the new configuration file on the computer.

29. The computer readable medium of claim 26, wherein the method further comprises:
determining whether a predetermined failure condition of the remote server has occurred; and
retrieving the appropriate cached known configuration file from the computer if the predetermined failure condition has occurred.

30. The computer readable medium of claim 29, wherein the predetermined failure condition is selected from a group consisting of directory server power outage, DHCP server power outage, network power outage, access pipeline failure, and overtaxed directory server.

31. A communications system, comprising:
a provisioning server connected to a central server, the central server storing configuration profile information for access devices connected to the provisioning server;
a data structure on the provisioning server storing configuration files corresponding to the configuration profile information for the access devices connected to the provisioning server; and
a computer readable medium for performing a method comprising:
retrieving a new configuration profile from the central server for an access device requesting access;
creating a new configuration file from the retrieved configuration profile if the central server is available;
retrieving a known configuration file from the provisioning server if the central server is unavailable; and
booting the device using the known configuration file if the central server is unavailable, and with the new configuration file if the central server is available.

32. The communications system of claim 31, wherein the provisioning server is a DHCP server.

33. The communications system of claim 31, wherein the data structure is stored on an external disk connected to the provisioning server.

34. The communications system of claim 31, wherein the method further comprises caching the new configuration file on the provisioning server.

35. A backup communications access system, comprising:
a secondary server storing configuration information for access devices also stored on a remote central server;
a data file stored on the secondary server, the data file containing configuration files compiled from the configuration information stored on the central server; and
a computer readable medium for performing a method comprising:
checking for availability of the central server upon receiving a request for access by a communications device connected to the secondary server;
retrieving configuration information for the device if the central server is available;
creating a new configuration file from the retrieved configuration information;
storing the new configuration file on the secondary server; and
retrieving a stored configuration file for the access device from the data file if the central server is unavailable.

36. The system of claim 35, wherein the secondary server is a provisioning server

37. The system of claim 35, and further comprising:
an external mass storage device, the external mass storage device containing the storage file.
